(19) United States
(12) Patent Application Publication
(10) Pub. No.: US 2025/0269419 A1
(43) Pub. Date: Aug. 28, 2025

(54) METHOD FOR MANUFACTURING A COVERING PANEL AND COVERING PANEL

(71) Applicant: M.A.C. METAL ARCHITECTURAL INC., Longueuil (CA)

(72) Inventors: Eric PARE, Candiac (CA); Francois BARIL-D’ULISSE, Saint-Basile-le-Grand (CA)

(21) Appl. No.: 19/060,287

(22) Filed: Feb. 21, 2025

Related U.S. Application Data
(60) Provisional application No. 63/557,115, filed on Feb. 23, 2024.

(30) Foreign Application Priority Data
Dec. 5, 2024 (CA) 3258553

(51) Int. Cl. B21D 43/28; B21D 43/02; B32B 15/01

(52) U.S. Cl. CPC B21D 43/287; B21D 43/02; B32B 15/013; B32B 2311/20

(57) ABSTRACT

A covering panel comprising at least one embossed line and a process for manufacturing the same are provided. The process includes unrolling continuously a covering material sheet from a supply roll, continuously conveying the covering material sheet along a conveying line towards an embossing apparatus having at least one embossing tool translatable in both directions along an axis perpendicular to the conveyance direction, translating the at least one embossing tool in the both directions along the axis and substantially parallel to covering material sheet, contacting the at least one embossing tool with a surface of the covering material sheet as the covering material sheet traverses the embossing apparatus with a pressure sufficient to create at least one embossing line on the covering material sheet, and cutting the covering material sheet to obtain a covering panel.

### CROSS-REFERENCES TO RELATED APPLICATIONS

This application claims the benefit of, and priority to, U.S. Provisional Patent Application No. 63/557,115, filed Feb. 23, 2024, and Canadian Patent Application No. 3,258,553, filed Dec. 5, 2024, both entitled “METHOD FOR MANUFACTURING A COVERING PANEL AND COVERING PANEL”, the disclosures of both of which are hereby incorporated by reference in their entirety.

### TECHNICAL FIELD

The technical field relates to covering panels and the manufacture of covering panels, and more specifically to covering panels including embossed lines and to methods for manufacturing covering panels including embossed lines.

### BACKGROUND

The traditional process for manufacturing embossed covering panels includes first manufacturing a die corresponding to the desired embossing pattern, then using a hydraulic press to press precut panels against the die to create embossed panels.

This process has inconvenients. First, covering panels must be inserted into and removed from the press one at a time to be embossed. This creates requires workforce and causes downtime. Second, if a different pattern is desired, a new die has to be manufactured, which is time consuming and costly.

There remains a need for an improved process capable of embossing continually and of creating different patterns without having to manufacture different dies.

### SUMMARY

The present disclosure is directed to a process for continuously embossing material sheet using an embossing apparatus in order to create an embossed covering material sheet continuously and in any desired pattern, which can be cut into covering panels.

In accordance with an aspect, a process for manufacturing covering panels is provided. The process includes unrolling continuously a covering material sheet from a supply roll, the covering material sheet having two spaced-apart longitudinal edges, continuously conveying the covering material sheet at a conveying speed along a conveying line towards an embossing apparatus having at least one embossing tool translatable in both directions along a translation axis extending perpendicular to the conveying line and between a first end and a second end, translating the at least one embossing tool in the both directions along the translation axis and substantially parallel to covering material sheet, contacting the at least one embossing tool with a surface of the covering material sheet as the covering material sheet traverses the embossing apparatus with a pressure sufficient to create at least one embossing line on the covering material sheet, each of the at least one embossing line defining a corresponding oblique angle with the longitudinal edges of the covering material sheet, and cutting the covering material sheet to obtain a covering panel.

In some embodiments, the covering material sheet comprises steel.

In some embodiments, the covering material sheet is galvanized.

In some embodiments, the covering material sheet has a galvanization deposition weight of at least 90 ounces per square foot.

In some embodiments, the covering material sheet has a yield strength of at least 33 kilopond force per square inch.

In some embodiments, conveying the covering material sheet is performed by a sheet material carrier communicatively connected to the embossing apparatus, further comprising detecting and communicating, by the sheet material carrier to the embossing apparatus, a baseline position of the covering material sheet.

In some embodiments, conveying the covering material sheet is performed by a sheet material carrier communicatively connected to the embossing apparatus, and the process further includes communicating, by the embossing apparatus to the sheet material carrier, an indication that a portion of the covering material sheet corresponding to a new covering panel is to be processed, and in response to the material feeding receiving the indication, momentarily slowing the conveying speed.

In some embodiments, the embossing apparatus comprises a linear screw actuator for each respective embossing tool, the linear screw actuator adapted to translating the respective embossing tool in the both directions along the translation axis.

In some embodiments, the embossing apparatus comprises a first controller adapted to controlling translating the at least one embossing tool in the both directions along the translation axis.

In some embodiments, the first controller is configured to read control commands defining an embossing pattern, and cause the embossing apparatus to apply the embossing pattern to the covering material sheet.

In some embodiments, each one of the at least one embossing line extends between the two longitudinal edges of the covering material sheet.

In some embodiments, the at least one embossing tool comprises at least two embossing tools translating simultaneously in opposite ones of the both directions.

In some embodiments, the at least one embossing tool each comprises a pneumatic actuator adapted to applying the pressure.

In some embodiments, the embossing apparatus comprises a second controller adapted to control the pressure based on at least one of the angle, the conveying speed, and mechanic properties of the covering material sheet.

In accordance with another aspect, a covering panel comprising at least one embossed line manufactured using the process described above is provided.

In accordance with a further aspect, a system for embossing covering material sheet to manufacture covering panels is provided. The system includes a sheet material carrier adapted to continuously convey the covering material sheet at a conveying speed along a conveying line, and an embossing apparatus. The embossing apparatus includes at least one embossing tool comprising at least one embossing head adapted to contact with a surface of the covering material sheet as the covering material sheet traverses the embossing apparatus, conveyed by the sheet material carrier, with a pressure sufficient to create at least one embossing line on the covering material sheet and manufacture an embossed covering material sheet, each of the at least one embossing line defining a corresponding oblique angle with the longitudinal edges of the covering material sheet, and at least one a translation actuator, each of the at least one translation actuator being adapted to translate a corresponding one of the at least one embossing tool in both directions along a translation axis extending perpendicular to the conveying line and between a first end and a second end.

In some embodiments, the at least one embossing tool comprises at least two embossing tools and wherein the translation actuator is configured to translate the at least two embossing tools simultaneously in opposite ones of the both directions.

In some embodiments, the system further includes a controller configured to control the pressure based on at least one of the angle, the conveying speed, and mechanic properties of the covering material sheet.

In some embodiments, the controller is further configured to read control commands defining an embossing pattern and control the conveying speed, the pressure and/or the translation to apply the embossing pattern to the covering material sheet.

In some embodiments, the system further includes a panel forming apparatus located downstream of the embossing apparatus and adapted to cut the embossed covering material sheet into substantially flat embossed covering panels.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment.

FIG. 1 is the schematic of a system for manufacturing covering panels including embossed lines in accordance with an embodiment.

FIG. 2 is a perspective view of an embossing apparatus used in the system of FIG. 1 in accordance with an embodiment.

FIG. 3 is a perspective view of an embossing tool used in the apparatus of FIG. 2 in accordance with an embodiment.

FIGS. 4a to 4d are illustrations of covering material sheet including one or more embossed lines in accordance with an embodiment and being substantially planar.

FIGS. 5a to 5d are illustrations of covering panels including one or more embossed lines in accordance with an embodiment and having fold lines defined in marginal edge regions thereof.

FIG. 6 is the flowchart of a method for manufacturing covering panels including embossed lines in accordance with an embodiment.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practised without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

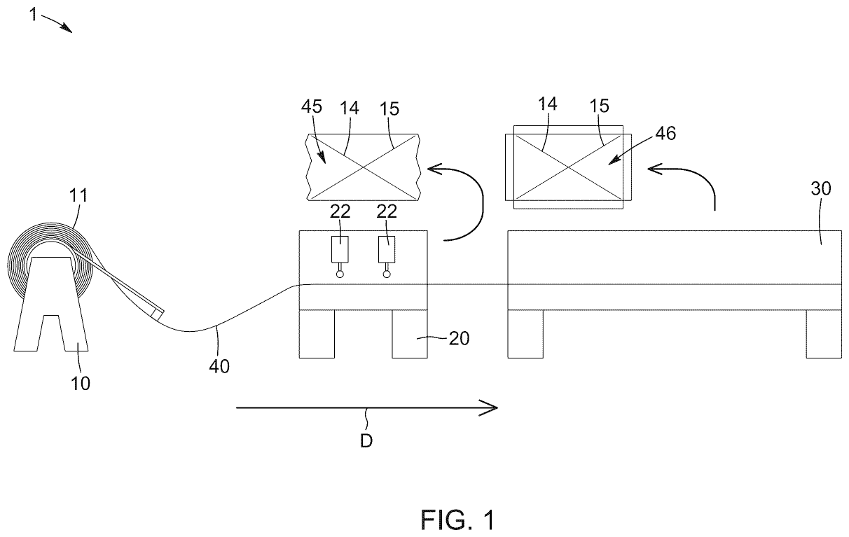

With reference to FIG. 1, a schematic of a system 1 for embossing lines in covering material sheet and/or manufacturing covering panels including embossed lines is provided in accordance with an example embodiment. Broadly described, the system 1 includes a decoiler 10 for unrolling a supply roll 11 of covering material sheet 40, an embossing apparatus 20 and a cutting apparatus (not shown).

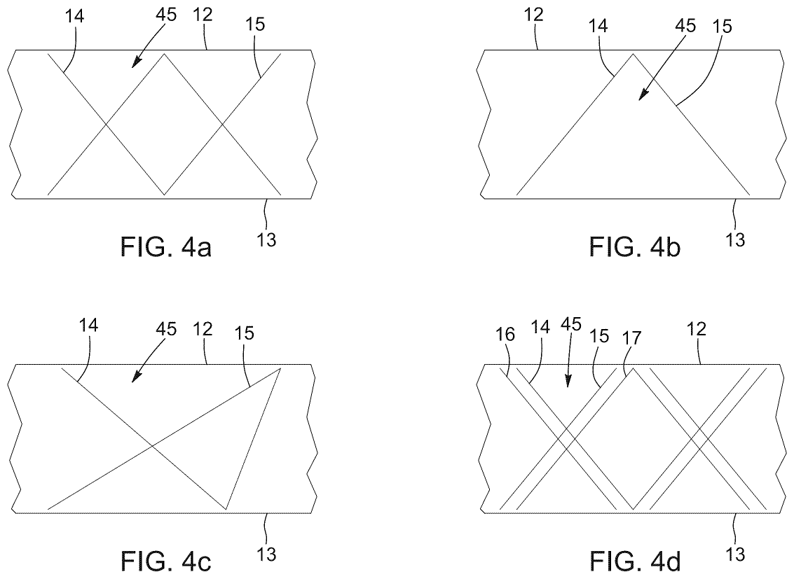

The decoiler 10 is adapted to unrolling continuously supply roll 11 of covering material sheet 40 for conveying into the embossing apparatus 20. The covering material sheet 40 includes two spaced-apart longitudinal edges 12, 13 (FIGS. 4a to 4d). In some embodiments, the covering material sheet 40 is provided in a substantially uniform width, e.g., with a 16-inch, a 24-inch or a 48-inch width, such that the longitudinal edges 12, 13 are substantially parallel and spaced apart by the width. In some embodiments, the covering material sheet 40 is steel, aluminum, an aluminum alloy, or a steel, aluminum and/or aluminum alloy composite material, for instance a material including one or more aluminum surfaces separated by and/or coated, e.g., with one or more types of thermoplastic polymers.

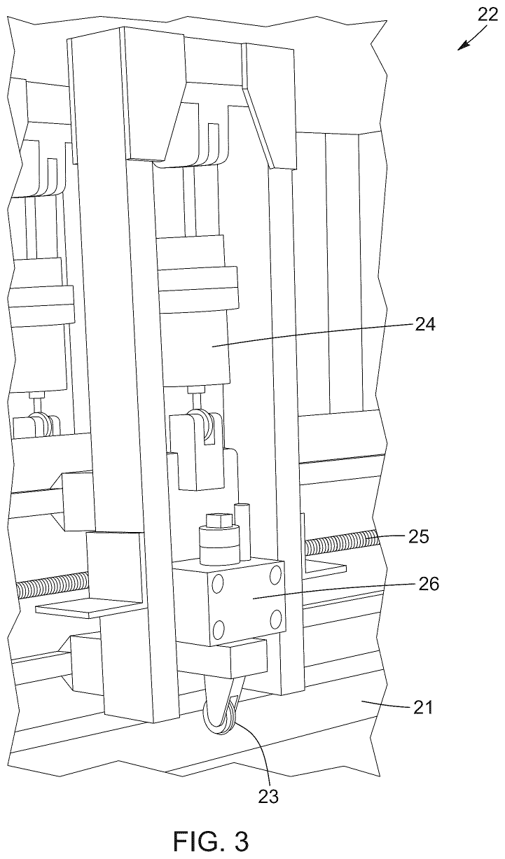

With refence to FIGS. 1 to 3, the system 1 further includes includes a sheet material carrier adapted to continuously convey covering material sheet 40 from the supply roll 11, for instance using one or more conveyor rollers 21 to the embossing apparatus 20. In some embodiments, the sheet material carrier is included in the embossing apparatus 20. In some embodiments, the embossing apparatus 20 is additionally or alternatively adapted to accept covering material sheet 40 continuously conveyed into the apparatus 20 by an external sheet material carrier. An examples only, the sheet material carrier can include a feed table, a nip roller assembly, and/or a roller conveyor. The conveyance direction D (represented by the arrow in FIG. 1) of the covering material sheet 40 through the embossing apparatus 20 is controlled by the sheet material carrier and defines a conveying line. In some implementations, the sheet material carrier can be motorized to pull the covering material sheet 40 therethrough. In some implementations, the sheet material carrier defines a conveying speed, i.e., a rate at which the covering material sheet 40 is conveyed through the apparatus 20. In some implementations, the sheet material carrier is controlled by a variable-frequency drive allowing the covering material sheet 40 to be conveyed at a configurable speed.

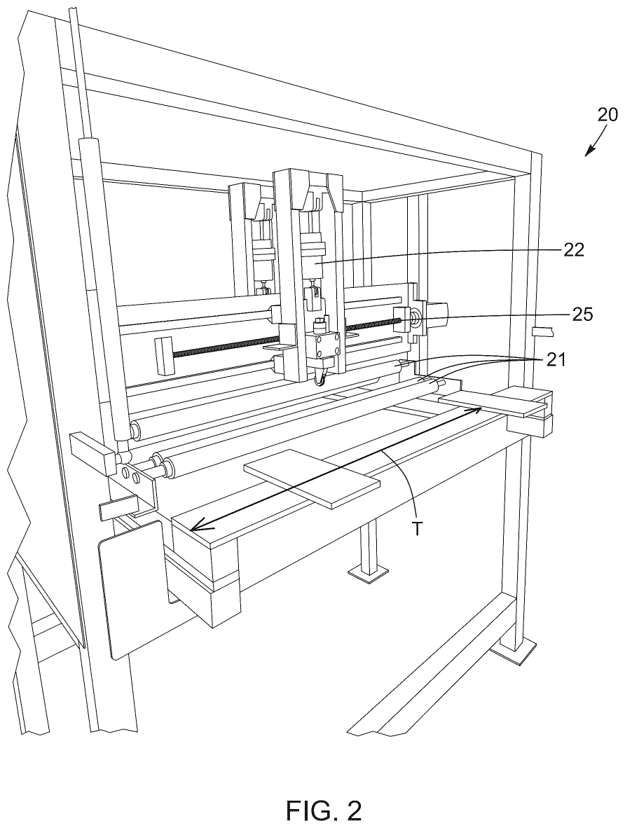

The embossing apparatus 20 includes at least one embossing tool 22 translatable in both directions along a translation axis T (FIG. 2) and adapted to creating embossing lines 14, 15 in the covering material sheet 40. The translation axis T can extend perpendicular to the conveying line, and can include a first end and a second end, the embossing tool(s) 22 being adapted to translate along the translation axis between the first end and the second end, defining therebetween a translation path. The translation path can have a length at least equal to the width of the covering material sheet. In some embodiments, the embossing apparatus 20 includes two embossing tools 22, adapted to create simultaneously two embossing lines 14, 15 in the covering material sheets. As an example, two embossing tools 22 can translate simultaneously in opposite directions along the translation axis T to create a rhomboid embossing pattern.

Each embossing tool 22 is adapted to contact with a surface of the covering material sheet 40 as the covering material sheet traverses the embossing apparatus 20 with a pressure sufficient to create at least one embossing line 14, 15 on the covering material sheet 40, yielding an embossed covering material sheet 45. In some embodiment, as the covering material sheet 40 traverses the embossing apparatus 20 along the conveying line, each embossing tool 22 translates along the translation axis T and substantially parallel to a width of the covering material sheet 40, as the covering material sheet 40 is conveyed continuously, thereby creating an embossing line defining an oblique angle with respect to the longitudinal edges 12, 13 of the covering material sheet 40.

In the non-limitative embodiment shown, the embossing lines 14, 15 are straight lines defining a non-void angle and, in some embodiments, an oblique angle at a junction with the longitudinal edges 12, 13 of the covering material sheet 40. It is appreciated that, in an alternative embodiment (not shown), the embossing lines 14, 15 can vary from the straight lines. For instance and without being limitative, they can have a curvature defined therein.

In some embodiments, one or more of the embossing tool(s) 22 includes at least one embossing head 23 extending towards the covering material sheet 40, the embossing head(s) 23 being adapted to contact with the surface of the covering material sheet to create the embossing line(s). In some embodiment, at least one of the embossing heads 23 is a roller of a suitable size, e.g., a substantially flat roller with a ¾″ radius and a ⅛″ width. In some embodiment, at least one of the embossing heads 23 is attached to the embossing tool 22 via a pressure adjustment assembly 24 or connected to a pressure adjustment assembly 24. In some embodiments, at least one of the embossing heads 23 is attached to the embossing tool 22 or the pressure adjustment assembly 24 via a swivel mechanism 26, including for instance a caster swivel, for instance enabling a roller used as an embossing head 23 to rotate and align itself with the angle of the embossing line.

The pressure adjustment assembly 24 can be used to adjust the contact pressure of the embossing head 23 with the covering sheet material, for instance to modify the depth of the embossing lines 14, 15, and/or to disengage the embossing head 23 from the covering sheet material, such that the covering sheet material 40 can be conveyed through the embossing apparatus 20 without creating embossing lines. In some embodiments, the pressure adjustment assembly 24 includes a threaded rod engaged with a corresponding threaded nut attached to the embossing head 23 and adapted to allowing a user to adjust the vertical position of the embossing head 23. In some embodiments, the pressure adjustment assembly 24 includes at least one pneumatic and/or hydraulic cylinders configured to function as a pneumatic and/or hydraulic actuator to exert pressure on the embossing head 23. In some embodiments, the pressure adjustment assembly 24 includes a pressure regulator configured to ensure that the air and/or fluid pressure supplied to the cylinder(s) matches the desired level required to achieve the desired force and/or to stabilize pressure fluctuations. In some embodiments, the pressure regulator is configured to adjust the pressure based on embossing parameters to ensure uniform results across different sets of parameters. The pressure regulator can be implemented in a controller including for instance a printed circuit board, a microcontroller unit and/or a programmable computer operably connected with the pressure adjustment assembly 24. Parameters that can affect the result of the embossing process include in particular the angle defined by the embossing line(s), the conveying speed of the covering material sheet, the translation speed of the embossing tool(s) 22, and/or mechanic properties of the covering material sheet such as its thickness and/or yield strength. In some embodiments, the controller can be communicatively connected to one or more sensors and/or to other controllers to determine the value of the parameters. In some embodiments, the controller can be communicatively connected to a human-machine interface to allow an operator to input at least some of the parameter values.

In some embodiments, the embossing apparatus 20 includes a translation actuator 25 adapted to perform the translation of the embossing tool(s) 22 along the translation axis T, each embossing tool 22 being attached to a translation actuator 25. A relative speed of the translation actuator 25 along the Taxis and the external sheet material carrier along the D axis can be adjustable to control the embossing line pattern. In some embodiment, each embossing tool 22 is attached to a corresponding, distinct translation actuator 25, allowing for the creation of two or more embossing lines with minimal or no distance between them, e.g., crossing lines. In some embodiments, the translation actuator 25 is a linear actuator, e.g., a linear screw actuator, adapted to translating the attached embossing tool(s) 22 in both directions along the translation axis between the first end and the second end, for instance through an electric motor such as a servomotor applying rotational force to the actuator 25. In some embodiments, the translation of the embossing tool(s) 22, including for instance its timing, direction and/or speed, is controlled by a controller including for instance a printed circuit board, a microcontroller unit and/or a programmable computer operably connected with the actuator.

In some embodiments, the sheet material carrier and/or the variable-frequency drive is communicatively connected to at least another apparatus, for instance the embossing apparatus 20 and/or the embossing tool(s) 22, through any suitable communication interface such as a serial or parallel communication bus or channel controlled, e.g., by a programmable logic controller of each or either device implementing a suitable data exchange protocol such as Modbus™, Profibus™, CANopen™ or EtherNet/IP™. In some embodiments, the sheet material carrier s is adapted to detect a baseline position of the covering material sheet, for instance using notches preformed in the material sheet, and communicate this baseline communication to the embossing apparatus 20 and/or the embossing tool(s) 22 such that the embossing tool(s) can be configured to apply an offset to its position based on the baseline position of the material sheet. In some embodiments, the connection is leveraged to allow the embossing apparatus 20 or another apparatus on the line to transmit an indication that a portion of the covering material sheet corresponding to a new covering panel is about to be processed, allowing the sheet material carrier to momentarily slow down the conveying speed to allow for the embossing tool(s) 22 to be repositioned at a suitable location for embossing the new covering panel. In some embodiments, the connection is leveraged to allow the translation actuator 25 of the embossing tool(s) 22 to adjust its translation speed based on the conveying speed to create embossing lines with a certain desired angle and/or pattern.

In some embodiments, a controller of the embossing apparatus 20 is configured to read and cause the embossing apparatus to execute control commands. The control commands can be provided for instance on a machine-readable medium configured to store a sequence of control commands that define an embossing pattern, i.e., a design to be embossed by the embossing apparatus 20 on the covering material sheet. The control commands can be provided in an existing machine-readable format defining actions to be executed and parameters, such as G-Code™, in a format defining a result to be obtained, such as the AutoCAD™ Drawing Interchange Format™, leaving the task of computing actions and parameters required to obtain the result to the controller, or in a format combining both aspects, such as STEP-NC™. The control commands can for instance control the timing, speed and direction of translation of the embossing tool(s) 22 and the pressure applied by the embossing tool(s) 22, as well as the conveying speed to achieve the specified angle(s) and/or pattern.

Advantageously, each embossing tool 22 can include components made and/or affixed with high-mechanical strength materials and/or a high-torque servomotor to operate the translation actuator 25, enabling the embossing head(s) 23 to contact the covering material sheet with a pressure sufficient to deform thick materials or materials with a high yield strength. In some embodiments, the embossing tool(s) 22 are adapted to create embossing lines in materials such as sheet metal including, as examples, steel, including for instance galvanized steel, and/or aluminum, including for instance anodized aluminum. The material can be of any suitable gauge and/or thickness. As examples, the covering material sheet can be 22, 24 or 26 gauge sheet steel, and/or have a thickness comprised between approximately 0.0188 and 0.0313 inches (ca. 0.48 and 0.80 mm). The material can be treated with any suitable surface treatment and/or coating process. As an example, the covering material sheet can be galvanized steel, e.g., steel coated with a suitable amount of galvanizing material such as zinc or a zinc alloy, e.g., a suitable deposition weight of galvanizing material, such as approximately 0.90 ounces per square foot (ca. 275 g/m²), corresponding to a G90 galvanization grade. It can be appreciated that these materials and/or surface treatments can result in the covering material sheet having a strong yield strength, such as for instance approximately 33 kilopond force per square inch (ca. 228 MPa) or more, for instance up to between approximately 37 and 55 kilopond force per square inch (ca. 255 and 379 MPa).

In some embodiments, the system 1 includes a cutting apparatus adapted to cut the embossed covering material sheet being conveyed out of the embossing apparatus 20 into substantially flat (or planar) covering panels 46. In some embodiments, the cutting apparatus is included in the embossing apparatus 20. In some embodiments, the cutting apparatus is included in a panel forming apparatus 30 adapted to cut the embossed covering material sheet being conveyed out of the embossing apparatus 20 into substantially flat covering panels 46 and shape them into covering panels 60 including folds in at least one of the marginal edge regions.

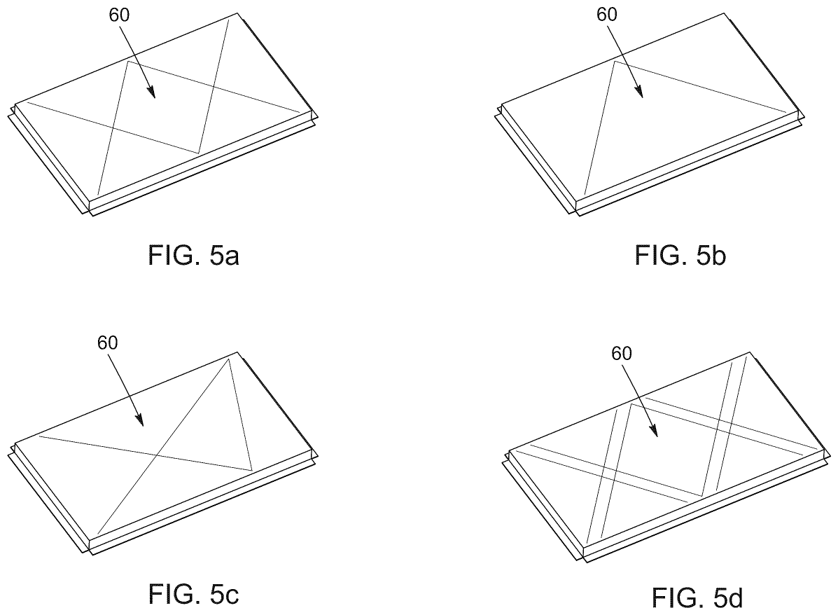

With reference to FIGS. 4a to 4d and 5a to 5d, illustrations of embossed covering material sheets 45 and covering panels 60 including folds in marginal edge regions thereof, respectively, and including at least one embossed line are shown in accordance with four example embodiments.

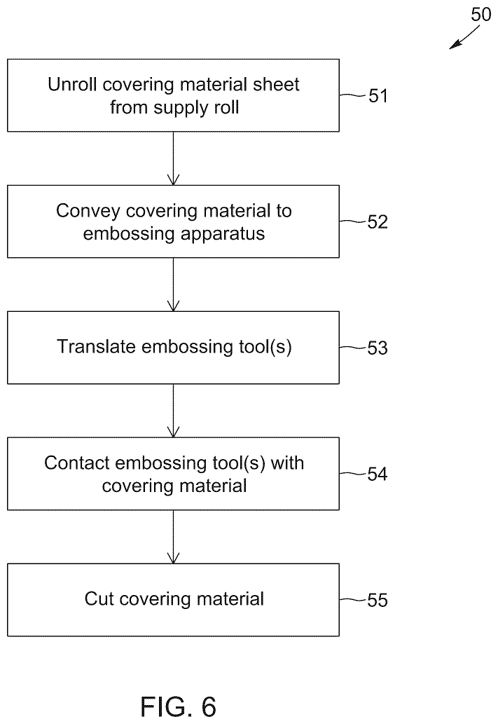

FIGS. 4a and 5a respectively illustrate an embossed covering material sheet 45 and a covering panel 60 manufactured using an embodiment using two embossing tools translating simultaneously in opposite directions, creating two embossed lines 14, 15. FIGS. 4b and 5b respectively illustrate an embossed covering material sheet 45 and a covering panel 60 manufactured using an embodiment using a single embossing tool, creating one embossed line 14. FIGS. 4c and 5c respectively illustrate an embossed covering material sheet 45 and a covering panel 60 manufactured using an embodiment using two embossing tools translating independently of one another following an intricate pattern, creating two embossed lines 14, 15. FIGS. 4d and 5d respectively illustrate an embossed covering material sheet 45 and a covering panel 60 manufactured using an embodiment using four embossing tools pairwisely translating simultaneously in opposite directions, creating four embossed lines 14, 15, 16, 17. The embossed sheets 45 and covering panels 60 of FIGS. 4a to 4d and 5a to 5d can for instance be manufactured using process 50 (FIG. 6) and/or system 1 (FIG. 1). It can be appreciated that the embossed lines 14, 15, 16, 18 extend between the two longitudinal edges 12, 13 of the sheets 46 and covering panels 60.

With reference to FIG. 6, the flowchart of a process 50 and/or method for manufacturing covering panels including embossed lines is provided in accordance with an example embodiment. Broadly described, process 50 includes unrolling a covering material sheet from a supply roll 51, conveying the covering material to an embossing apparatus 52, translating the embossing tool(s) of the embossing apparatus 53, contacting the embossing tool(s) with the covering material 54 while they are translated and the covering material is conveyed continuously, and cutting the covering material 55. Process 50 can for instance be performed using the system 1 described above.

While the steps below are described as a sequence, it can be appreciated that each step is to be performed continually during the manufacture of the covering panels, such that all the steps are performed substantially at the same time on different portions of the unrolled covering material sheet.

In a first step 51, a covering material sheet is unrolled from a supply roll. The covering material sheet can have two spaced-apart longitudinal edges.

In a second step 52, the covering material sheet is conveyed continuously along a conveying line towards an embossing apparatus. The embossing apparatus has at least one embossing tool which is translatable in both directions along a translation axis. The translation axis can extend perpendicular to the conveying line. The translation axis can extend between a first end and a second end.

In a third step 53, the embossing tool(s) is (are) translated in both directions along the translation axis. The embossing tool(s) can be translated substantially parallel to a width of the covering material sheet. In some embodiments, the embossing tool(s) is (are) translated using a translation actuator of the embossing apparatus, such as a linear screw actuator. The actuator can for instance be controlled by a controller including for instance a printed circuit board, a microcontroller unit and/or a programmable computer. In some embodiments, the embossing apparatus includes two embossing tools, and step 53 can include translating a first embossing tool in a first direction while simultaneously translating a second embossing tool in a second direction, opposed to the first direction.

In a fourth step 54, the embossing tool(s) is (are) contacted with a surface of the covering material sheet, as the covering material sheet traverses the embossing apparatus at a substantially constant speed. The contact pressure is sufficient to create at least one embossing line on the covering material sheet. Each embossing line can define an oblique angle with the longitudinal edges of the covering material sheet. In some embodiments, the embossing line(s) extends between the two longitudinal edges of the covering material sheet. In some embodiments, an embossing head of each embossing tool is contacted with the surface of the covering material sheet.

In a fifth step 55, the covering material sheet is cut to obtain a substantially flat covering panel 46. In some embodiment, the covering material sheet is also shaped, e.g., including folding marginal edges thereof, to form a covering panel 60. In some embodiments, this step can be performed in the embossing apparatus. In some embodiments, this step can be performed in a cutting and/or shaping apparatus.

While the above description provides examples of the embodiments, it will be appreciated that some features and/or functions of the described embodiments are susceptible to modification without departing from the spirit and principles of operation of the described embodiments.

Accordingly, what has been described above has been intended to be illustrative and non-limiting and it will be understood by persons skilled in the art that other variants and modifications may be made without departing from the scope of the invention as defined in the claims appended hereto.

1. A process for manufacturing covering panels, the process comprising:
unrolling continuously a covering material sheet from a supply roll, the covering material sheet having two spaced-apart longitudinal edges;
continuously conveying the covering material sheet at a conveying speed along a conveying line towards an embossing apparatus having at least one embossing tool translatable in both directions along a translation axis extending perpendicular to the conveying line and between a first end and a second end;
translating the at least one embossing tool in the both directions along the translation axis and substantially parallel to covering material sheet;
contacting the at least one embossing tool with a surface of the covering material sheet as the covering material sheet traverses the embossing apparatus with a pressure sufficient to create at least one embossing line on the covering material sheet, each of the at least one embossing line defining a corresponding oblique angle with the longitudinal edges of the covering material sheet; and
cutting the covering material sheet to obtain a covering panel.

2. The process of claim 1, wherein the covering material sheet comprises steel.

3. The process of claim 1, wherein the covering material sheet is galvanized.

4. The process of claim 3, wherein the covering material sheet has a galvanization deposition weight of at least 90 ounces per square foot.

5. The process of claim 1, wherein the covering material sheet has a yield strength of at least 33 kilopond force per square inch.

6. The process of claim 1, wherein conveying the covering material sheet is performed by a sheet material carrier communicatively connected to the embossing apparatus, further comprising detecting and communicating, by the sheet material carrier to the embossing apparatus, a baseline position of the covering material sheet.

7. The process of claim 1, wherein conveying the covering material sheet is performed by a sheet material carrier communicatively connected to the embossing apparatus, further comprising:
communicating, by the embossing apparatus to the sheet material carrier, an indication that a portion of the covering material sheet corresponding to a new covering panel is to be processed; and
in response to the material feeding receiving the indication, momentarily slowing the conveying speed.

8. The process of claim 1, wherein the embossing apparatus comprises a linear screw actuator for each respective embossing tool, the linear screw actuator adapted to translating the respective embossing tool in the both directions along the translation axis.

9. The process of claim 1, wherein the embossing apparatus comprises a first controller adapted to controlling translating the at least one embossing tool in the both directions along the translation axis.

10. The process of claim 9, wherein the first controller is configured to:
read control commands defining an embossing pattern; and
cause the embossing apparatus to apply the embossing pattern to the covering material sheet.

11. The process of claim 1, wherein each one of the at least one embossing line extends between the two longitudinal edges of the covering material sheet.

12. The process of claim 1, wherein the at least one embossing tool comprises at least two embossing tools translating simultaneously in opposite ones of the both directions.

13. The process of claim 1, wherein the at least one embossing tool each comprises a pneumatic actuator adapted to applying the pressure.

14. The process of claim 13, wherein the embossing apparatus comprises a second controller adapted to control the pressure based on at least one of the angle, the conveying speed, and mechanic properties of the covering material sheet.

15. A covering panel comprising at least one embossing line manufactured using a process comprising:
unrolling continuously a covering material sheet from a supply roll, the covering material sheet having two spaced-apart longitudinal edges;
continuously conveying the covering material sheet at a conveying speed along a conveying line towards an embossing apparatus having at least one embossing tool translatable in both directions along a translation axis extending perpendicular to the conveying line and between a first end and a second end;
translating the at least one embossing tool in the both directions along the translation axis and substantially parallel to covering material sheet;
contacting the at least one embossing tool with a surface of the covering material sheet as the covering material sheet traverses the embossing apparatus with a pressure sufficient to create the at least one embossing line on the covering material sheet, each of the at least one embossing line defining a corresponding oblique angle with the longitudinal edges of the covering material sheet; and
cutting the covering material sheet to obtain the covering panel.

16. A system for embossing covering material sheet to manufacture covering panels, the system comprising:
a sheet material carrier adapted to continuously convey the covering material sheet at a conveying speed along a conveying line; and
an embossing apparatus comprising:
at least one embossing tool comprising at least one embossing head adapted to contact with a surface of the covering material sheet as the covering material sheet traverses the embossing apparatus, conveyed by the sheet material carrier, with a pressure sufficient to create at least one embossing line on the covering material sheet and manufacture an embossed covering material sheet, each of the at least one embossing line defining a corresponding oblique angle with the longitudinal edges of the covering material sheet, and
at least one a translation actuator, each of the at least one translation actuator being adapted to translate a corresponding one of the at least one embossing tool in both directions along a translation axis extending perpendicular to the conveying line and between a first end and a second end.

17. The system of claim 16, wherein the at least one embossing tool comprises at least two embossing tools and wherein the translation actuator is configured to translate the at least two embossing tools simultaneously in opposite ones of the both directions.

18. The system of claim 16, further comprising a controller configured to control the pressure based on at least one of the angle, the conveying speed, and mechanic properties of the covering material sheet.

19. The system of claim 18, wherein the controller is further configured to read control commands defining an embossing pattern and control the conveying speed, the pressure and/or the translation to apply the embossing pattern to the covering material sheet.

20. The system of claim 16, further comprising a panel forming apparatus located downstream of the embossing apparatus and adapted to cut the embossed covering material sheet into substantially flat embossed covering panels.
